(19) United States
(12) Patent Application Publication
(10) Pub. No.: US 2005/0073726 A1
(43) Pub. Date: Apr. 7, 2005

(54) IMAGE PROCESSING DEVICE AND METHOD

(76) Inventors: HIROSHI NOBUTA, YOKOHAMA-SHI (JP); HIROMICHI NAGANE, YOKOHAMA-SHI (JP); MASAHIRO SAKAMOTO, TOKYO (JP); KOICHI MATSUMOTO, TOKYO (JP)

Correspondence Address: FITZPATRICK CELLA HARPER & SCINTO, 30 ROCKEFELLER PLAZA, NEW YORK, NY, 10112, US

(21) Appl. No.: 08/579,733

(22) Filed: Dec. 28, 1995

(30) Foreign Application Priority Data
Dec. 28, 1994 (JP) 6-328329
Dec. 28, 1994 (JP) 6-328328
Dec. 28, 1994 (JP) 6-328327
Dec. 28, 1994 (JP) 6-328326

(51) Int. Cl. H04N 1/32

(52) U.S. Cl. 358/468

(57) ABSTRACT

An image processing device connected to a scanner unit for generating a first image signal has a first bidirectional interface for receiving a second image signal from an external computer and a second bidirectional interface for transmitting the first or second image signal to a printer unit. The second bidirectional interface receives a first status signal related to the printer unit and the first bidirectional interface transmits the first status signal and a second status signal related to the scanner unit to the external computer. Therefore, the external computer, which is able to process image data to be printed by the printer unit, can be advised of the status of the printer unit without being directly connected thereto. Therefore, in a first copy mode, the computer can process the image data, while in a second copy mode, the device itself can process the image data.

### BACKGROUND OF THE INVENTION

1. Field of the Invention

The present invention relates to an image processing device and method and, more particularly, to an image processing device and method which allow to perform various image processing by connecting the device to a separate computer.

2. Description of the Prior Art

Most conventional copying machines in which a scanner unit and a printer unit are integrally arranged operate alone and have all functions necessary for a copy operation.

However, since such a copying machine having all functions must incorporate various functions of its own, its requirement for a computer with a high throughput and a bulk memory makes it difficult to achieve a low price.

When these units are connected to a computer and used as an input/output equipment, processing on the computer side has a limitation because the units independently perform processing. When only the scanner unit or only the printer unit is to be operated, each unit must process specific data. In addition, since the interface and control method are also specific, these units must be dedicated to a specific computer. Therefore, if the computer is exchanged, all resources are wasted.

To connect a conventional scanner to a host computer, a special cable based on a predetermined interface specification must be used.

In a copying machine having a scanner unit and a printer unit, a control unit including the scanner unit is arranged integral with the printer unit.

However, when the type of the host computer is changed, all resources including the I/O equipment connected to the computer are wasted.

Although an interface for data communication is used for connection in some cases, the data communication control procedures are complex, and a problem of processing rate is posed. For example, an output from a scanner is a video signal. This signal is sent to the host computer through a dedicated interface, e.g., an interface based on the SCSI specifications.

Similarly, when a conventional printer is to be connected to a computer, special connection according to an interface specification for the printer is necessary.

To connect a scanner and a printer to a host computer, a plurality of interface means based on different specifications must be provided on the host computer side. For this reason, connection is difficult for users, and preparation for a plurality of interfaces is costly.

### SUMMARY OF THE INVENTION

It is an object of the present invention to solve the above problem.

It is another object of the present invention to provide a relatively inexpensive image processing device compatible with various computers and having versatility.

In order to achieve the above object, according to one aspect of the present invention, there is provided an image processing device having an arrangement in which a color image signal is input from a scanner unit, the image signal input from the scanner unit is supplied to a bus, and the image signal is transferred, through a first bidirectional interface, from the bus to a computer arranged separately from the scanner unit, and the image signal processed by the computer is transferred from the bus to a printer unit through a second bidirectional interface having the same data standards as those of the first bidirectional interface.

It is another object of the present invention to provide a device capable of effectively using an image processing function in an external computer to achieve high-speed image processing and size reduction of the device main body, and performing a simple operation such as a copy operation in a stand-alone manner independently of the computer.

In order to achieve the above object, according to another aspect of the present invention, there is provided an image processing device having an arrangement in which an image signal is input, the input image signal is processed using an internal circuit, and the image signal is transferred to an external computer and processed. With this arrangement, the image signal processed using the internal circuit without using the external computer is output in a first mode, and the image signal processed using the external computer is output in a second mode.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing the arrangement of an image processing system including an image processing device according to an embodiment of the present invention;

FIG. 2 is a view for explaining an initial menu screen on the host computer side of the image processing system in FIG. 1;

FIG. 3 is a view for explaining a display screen on the host computer side of the image processing system in FIG. 1, which is set for a color image read operation;

FIG. 4 is a view for explaining a display screen on the host computer side of the image processing system in FIG. 1, which is set for a color print operation;

FIG. 5 is a view for explaining a display screen on the host computer side of the image processing system in FIG. 1, which is set for a color copy operation;

FIG. 6 is a view for explaining a display screen on the host computer side of the image processing system in FIG. 1, which is set to determine the details of image input/output processing;

FIG. 7 is a view for explaining a display screen on the host computer side of the image processing system in FIG. 1, which is set to set the details of color balance;

FIG. 8 is a view for explaining a display screen on the host computer side of the image processing system in FIG. 1, which is set to set the details of image density;

FIG. 9 is a block diagram for explaining the flow of signals in the color image read operation mode of the image processing system in FIG. 1;

FIG. 10 is a block diagram for explaining the flow of signals in the color print mode of the image processing system in FIG. 1;

FIG. 11 is a block diagram for explaining the flow of signals in the color copy mode of the image processing system in FIG. 1;

FIG. 12 is a block diagram showing the arrangement of an image processing system including an image processing device according to another embodiment of the present invention;

FIG. 13 is a block diagram for explaining the flow of signals in the color image read operation mode of the image processing system in FIG. 12;

FIG. 14 is a block diagram for explaining the flow of signals in the color print mode of the image processing system in FIG. 12; and

FIG. 15 is a block diagram for explaining the flow of signals in the color copy mode of the image processing system in FIG. 12.

### DETAILED DESCRIPTION OF THE PREFERRED EMBODIMENTS

An embodiment of the present invention will be described below with reference to the accompanying drawings.

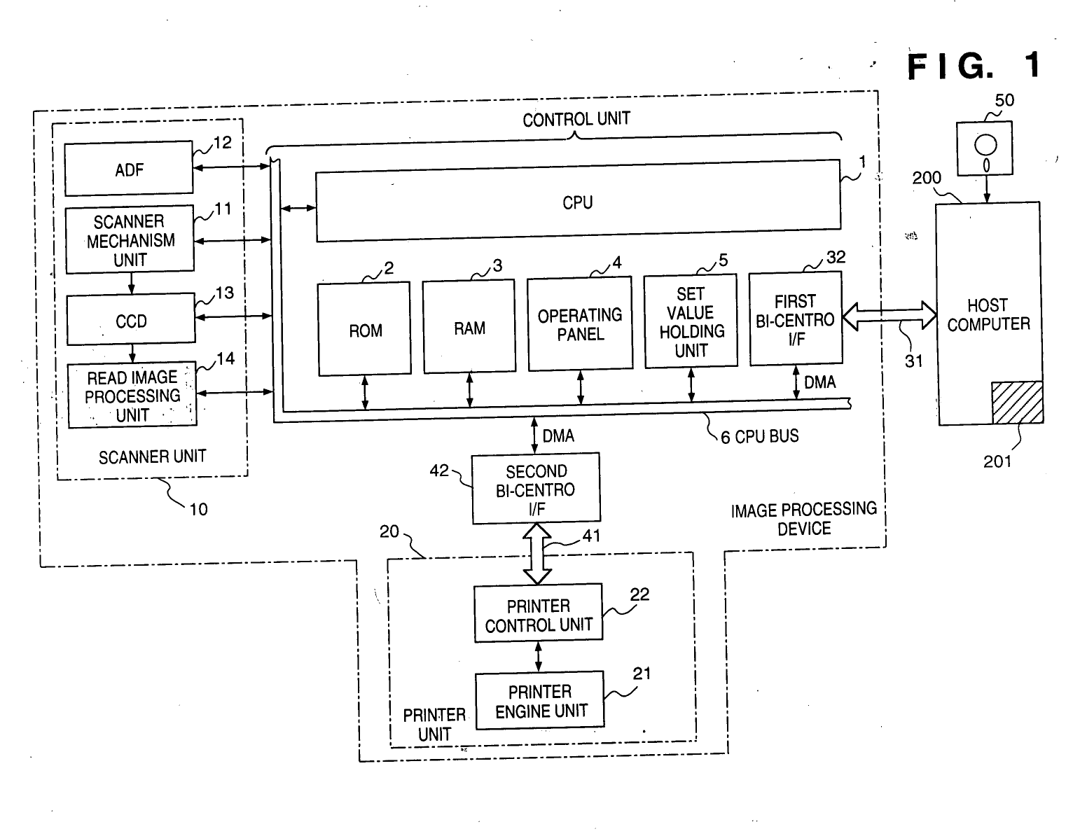

FIG. 1 is a block diagram showing the arrangement of an image processing device according to an embodiment of the present invention.

Referring to FIG. 1, reference numeral 1 denotes a CPU for controlling the entire device; 2, a ROM for storing the control procedures of the CPU 1 and also storing the default values for a scanner and a printer (to be described later), which are used for color image processing; and 3, a RAM for temporarily storing read data from the scanner or print data to the printer. Reference numeral 4 denotes an operating panel unit for inputting a copy operation start instruction or the like, in which a power switch, an on-line/off-line key, a monochrome copy key, a color copy key, a stop key, and the like are arranged. The types of keys are not limited to these. Instead, only a start key is provided, and all the remaining functions may be enabled by instructions from a host computer 200.

Reference numeral 5 denotes a set value holding unit for temporarily holding various set values such as a color adjustment set value for a scanner unit 10 for custom color image processing, or various set values for color image processing, which are set from the host computer 200, including output color adjustment set values for a connected printer unit 20. The stored contents of the set value holding unit 5 are protected by a backup power supply. The above-described elements constitute the control unit of this device.

Reference numeral 11 denotes a scanner mechanism unit for reading a set original image; 12, an automatic document feeder (ADF) for conveying read originals to the original read position of the scanner mechanism unit 11 one by one; and 13, a CCD on which an image read from an original is formed. The image is converted to a corresponding electrical signal and output. The CCD 13 can detect three primary colors such as red (R), green (G), and blue (B) so that a color image can be read. Reference numeral 14 denotes a read image processing unit for receiving a read color-image signal from the CCD 13, converting the image signal to multivalued or binary data, performing predetermined processing in accordance with set values held by the set value holding unit 5 or default values specific for the scanner, which are stored in the ROM 2, i.e., performing processing of converting the signal form of a color image from the scanner unit 10, which is unique to the scanner, to a signal form commonly processible by the CPU 1, the computer 200, and the printer unit 20, and also performing control such that a predetermined amount of the processed read image is stored in a predetermined memory area of the RAM 3 under control by, e.g., the CPU 1. The read image processing unit 14 is directly connected to the CPU 1 through a CPU bus 6. Transfer of read data to, e.g., the RAM 3 is performed using direct memory access (DMA). The above elements constitute the scanner unit 10 of this embodiment, which can read a color original. The scanner unit 10 is directly connected to the CPU 1 through the CPU bus 6, as described above. The arrangement of a conventional color scanner can be applied to the scanner unit for general purpose.

To connect the device of this embodiment and the host computer 200, this device has a first bi-centro interface 32 having an interface function of the bi-centronics standard (to be referred to as a “bi-centro” hereinafter) based on the IEEE-P1284 standards which are being established. The device can be connected to the host computer 200 through the bi-centro interface, i.e., a very simple communication medium.

The device also has a second bi-centro interface 42 having the interface function of the bi-centronics standards based on the IEEE-P1284 standards to connect the printer unit 20 (to be described later). The device can be connected to the printer unit 20 (to be described later) through the bi-centro interface, i.e., a very simple communication medium.

The printer unit 20 connectable to the second bi-centro interface 42 will be described below. In the following description, an ink-jet color printer will be exemplified. However, the connectable printer is not limited to this, and can be easily replaced with an electrophotographic printer, a thermal printer, or any other printer connectable through the bi-centro interface.

As shown in FIG. 1, the printer unit 20 comprises a printer engine unit 21 capable of performing a color print operation, and a printer control unit 22 for controlling the printer engine unit and performing predetermined processing in accordance with set values held by the set value holding unit 5 or default values stored in the ROM 2. The printer control unit 22 has a bi-centro interface function so that it can perform various control and data transmission/reception with respect to the second bi-centro interface in accordance with the bi-centro interface standards.

Data transmission/reception between the second bi-centro interface 42 and the CPU 1 can be performed using DMA at a high speed. The printer control unit 22 receives print data through the second bi-centro interface 42 and performs necessary image processing. Thereafter, the printer control unit 22 controls the printer engine unit 21 to convey recording paper and forms a print image on the recording paper with colors according to set values held by the set value holding unit 5 or default values registered in the ROM 2. The printer control unit 22 is preferably constituted by, e.g., a microprocessor and accompanying ROM and RAM, and each processing is preferably constituted by software. With this arrangement, hardware arrangement can be simplified.

In this embodiment, the scanner unit 10 is detachably mounted on the printer unit 20, and the control unit is arranged integral with the scanner unit. Therefore, the printer unit 20 can be easily detached from the scanner unit 10 to facilitate maintenance of the printer unit 20.

In this embodiment, the device including the scanner unit is connected to the host computer through the bi-centro interface. For this reason, the arrangement of the interface unit can be simplified, and data transfer rate can be increased. In addition, an image processing device usable only by connecting a bi-centro interface as a most popular interface for a printer and connectable to any computer is provided. The printer unit 20 is also connected through said bi-centro interface, so any other printer can be easily connected.

The host computer 200 is connected to the image processing device of this embodiment through an interface, which is operated by reading a control program 50 for the image processing device of this embodiment, thereby controlling the device of this embodiment. The host computer 200 also has a facsimile modem 201 such that a color image signal from the scanner unit 10 can be processed and transmitted to a reception-side device through a public telephone line. Similarly, a color image signal from the reception-side device can be processed, and then transferred to and printed out at the printer unit 20.

To cope with, e.g., personal use, it is essential to make the arrangement of the device main body as simple as possible and reduce the manufacturing cost. Various image processing of a read image and various image processing for print output, including reproduced color space matching processing for print output, are partially performed using the host computer 200. A program for this processing is stored in, e.g., a flexible disk or a CD-ROM and sold together with the image processing device of this embodiment.

With the above arrangement, the user can use the device of this embodiment, by causing his/her personal computer to read and register this processing program and operating this program. More specifically, general image processing of a read image and general image processing of an edit image in correspondence with the connected printer are performed in accordance with the control program stored in the host computer 200. With this arrangement, the device main body can be constituted by necessary and minimum parts while mainly using mechanical parts, thereby reducing the price of the device main body.

Image processing and device control are mainly performed on the host computer 200 side. Therefore, when upgrading of the device is required in accordance with an improvement in image processing technique, the control program need only be exchanged without exchanging the entire device or improving the internal arrangement of the device by a special serviceman. A large advantage in maintenance can also be achieved.

In the device of this embodiment, the control unit can be easily detached from the printer unit 20, as described above. Since both the units are connected through a simplified interface called a bi-centro interface, they can be easily separated from each other. Only the printer, the scanner unit, or the control unit can be easily replaced. To easily cope with this replacement, only a control program according to the new arrangement need be registered. Therefore, a device with a high expandability can be provided.

The program 50 for controlling the device of this embodiment includes an arrangement with a single driver capable of executing at least three modes: a color read operation mode wherein the host computer 200 uses this device as a color image reading device; a color print operation mode wherein this device is used as a color printing device; and a color copy operation mode wherein this device is used as a color copying device. In addition, a program corresponding to a set operation mode for performing various set operations including setting for image processing is also included in the control program 50. When the operator of the host computer 200 is to use this device in any one of the above modes during execution of an application program, the OS program of the host computer 200 starts the driver to realize a desired operation. Drivers corresponding to the above three operation modes can also be prepared.

Various operation modes according to this embodiment and operations from the display (not shown) of the host computer 200 in the respective modes will be described below.

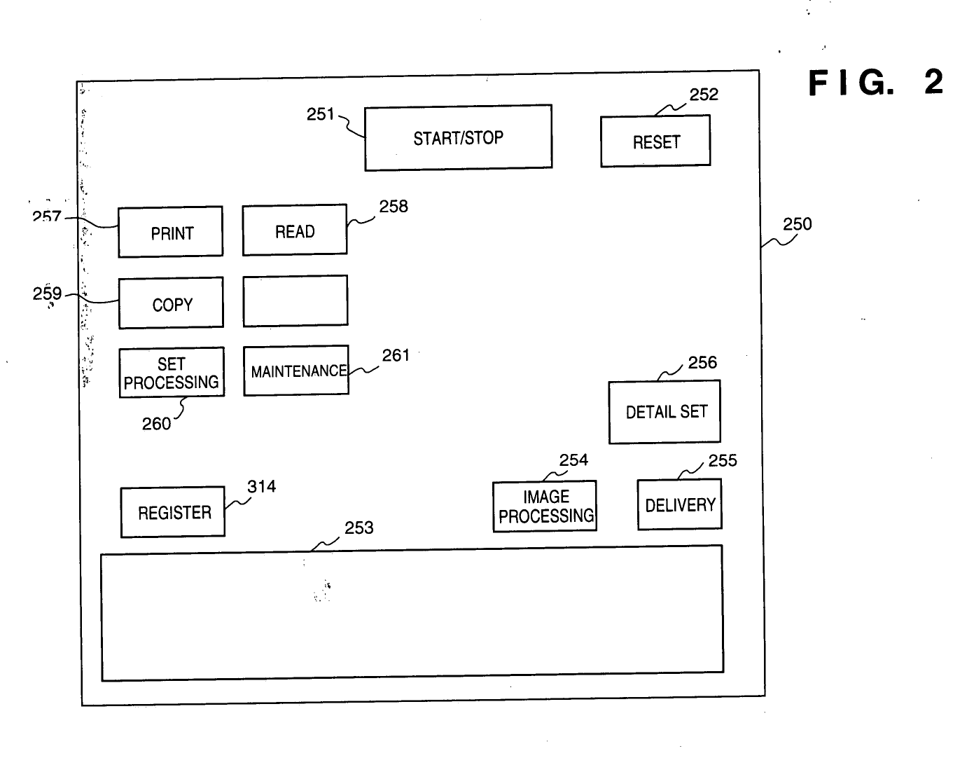

In this embodiment, various adjustment operations can be performed from the host computer. FIG. 2 shows an initial menu in the operation of the device of this embodiment. In the example shown in FIG. 2, detailed control instructions or detailed settings are not illustrated because a simple operation of the device can be executed by a simple operation.

Referring to FIG. 2, reference numeral 250 denotes a display screen; 251, a start/stop key for designating start/stop; 252, a reset key; 253, a status display of the image processing device (e.g., display of various statuses upon shift to this screen); 254, an image processing key selected to designate detailed image processing; 255, a delivery key for designating forced delivery of the printer unit 20; 256, a detail set key for setting details; 257, a print key for designating to print and output print information designated before shift to this program from the printer unit 20; 258, a read key for designating to read a color original from the scanner unit 10; 259, a copy key for designating to read an original from the scanner unit 10 and print and output the original from the printer unit 20; 260, a set processing key for reading and registering various set values: and 261, a maintenance mode key used for maintenance.

In this display, when an original is to be read from the scanner in accordance with current set values, the read key 258 is depressed, and thereafter, the start/stop key 251 is depressed. In a copy or print/output operation as well, the copy key 259 or the print key 257 is depressed, and thereafter, the start/stop key 251 is depressed.

To change the values set in advance in the state shown in FIG. 2, a desired one of the print, the read, and the copy keys is depressed, and thereafter, the detail set key 256 is depressed.

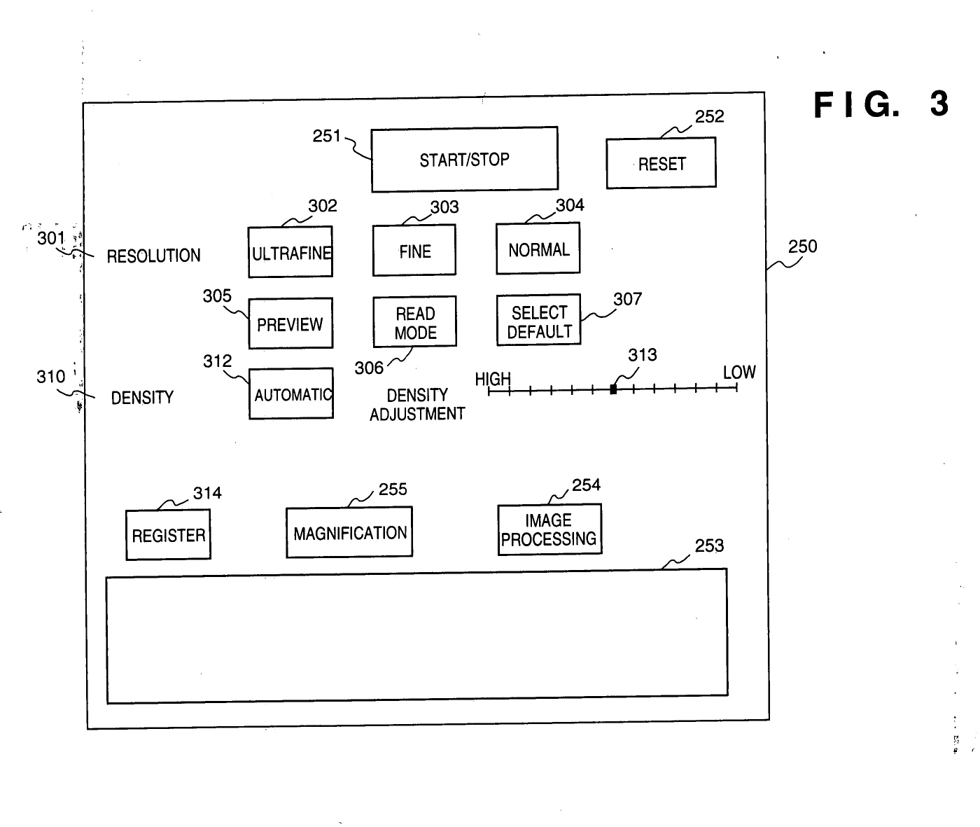

When the detail set key 256 is depressed after the read key 258 is depressed, the display in FIG. 2 shifts to FIG. 3, i.e., detailed setting for the scanner unit 10. To adjust a resolution 301, the read resolution of the scanner 10 can be designated by an ultrafine key 302 for designating a read operation in an ultrahigh resolution mode, a fine key 303 for designating a read operation in a high resolution mode, and a normal key 304 for designating a read operation in a normal resolution mode. These keys are omitted if the resolution of the scanner unit 10 cannot be changed.

In addition, a preview key 305 for designating a preview read operation in which a trial is performed as an operation mode unique to the scanner unit 10 and used as a supplement of adjustment, a read mode key 306 for designating a color read mode or a monochrome read mode (excluding the read resolution), a default select key 307 for designating a read operation according to default values registered in the ROM 2 of the device, a magnification key 308 for switching the read magnification of the scanner, and the like are displayed. Read density adjustment 310 can also be performed. If an automatic key 312 is selected, the optimum density is automatically selected, readjusted, and read. Otherwise, a bar 313 is freely moved using a mouse or the like, thereby reading an original at a manually set read density. If the set values are to be used in the future, a register key 314 is depressed upon completion of settings to send the set values to the set value holding unit 5. After setting the values in the set value holding unit 5, an original is read in accordance with the set values in principle until these values are reset.

When a read operation is to be performed upon completion of setting, the start/stop key 251 on the upper side is depressed.

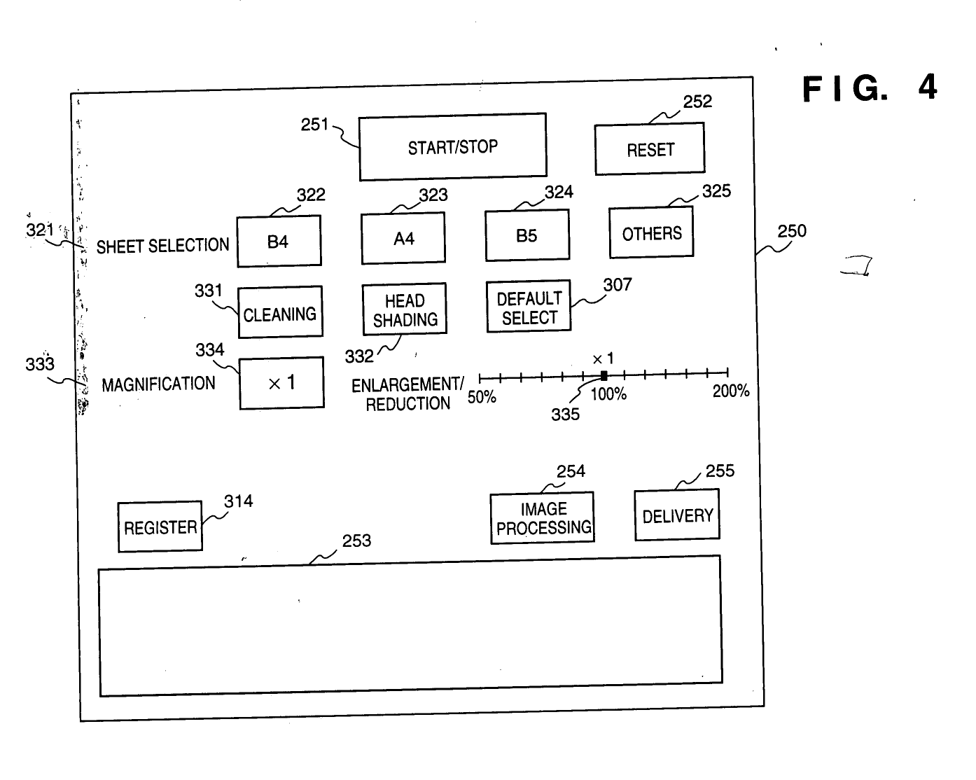

When the print key 257 and the detail set key 256 are selected and depressed on the initial menu, the display shifts to FIG. 4.

That is, the display shifts to settings of details of the printer unit 20. As keys (321) for selecting a recording paper sheet to be printed and output, a B4 key 322 for selecting a B4 paper sheet, an A4 key 323 for selecting an A4 paper sheet, a B5 key 324 for selecting a B5 paper sheet, and an “others” key 325 for selecting a paper size unique to this device are displayed. By depressing each key, a print operation with the input paper size is performed. In this embodiment, the paper size selection result is displayed on the status display portion 253 where the status is displayed.

In addition, a cleaning key 331 for executing cleaning of the recording head, which is an operation mode unique to the printer unit 20, a head shading key for performing head shading, a default select key 307 for designating a print operation according to default values registered in the ROM 2 of the device, and the like are displayed. Magnification adjustment 333 in the print operation is also possible. If a x1 key 334 is selected, print/output processing at a magnification of x1 (100%) is automatically performed. Otherwise, a bar 335 is freely moved by a mouse or the like, thereby performing print/output processing at a manually set magnification. Although not illustrated, a specific click point is provided for size change at a predetermined magnification (enlargement/reduction between the above paper sizes). When a portion near this point is clicked, the corresponding magnification is automatically set.

When the set value is to be used in the future, the register key 314 is depressed upon completion of setting to send the set value to the set value holding unit 5. After setting in the set value holding unit 5, a print/output operation is performed in accordance with this set value until it is reset.

When the printing operation is to be performed upon completion of setting, the start/stop key 251 on the upper side is depressed.

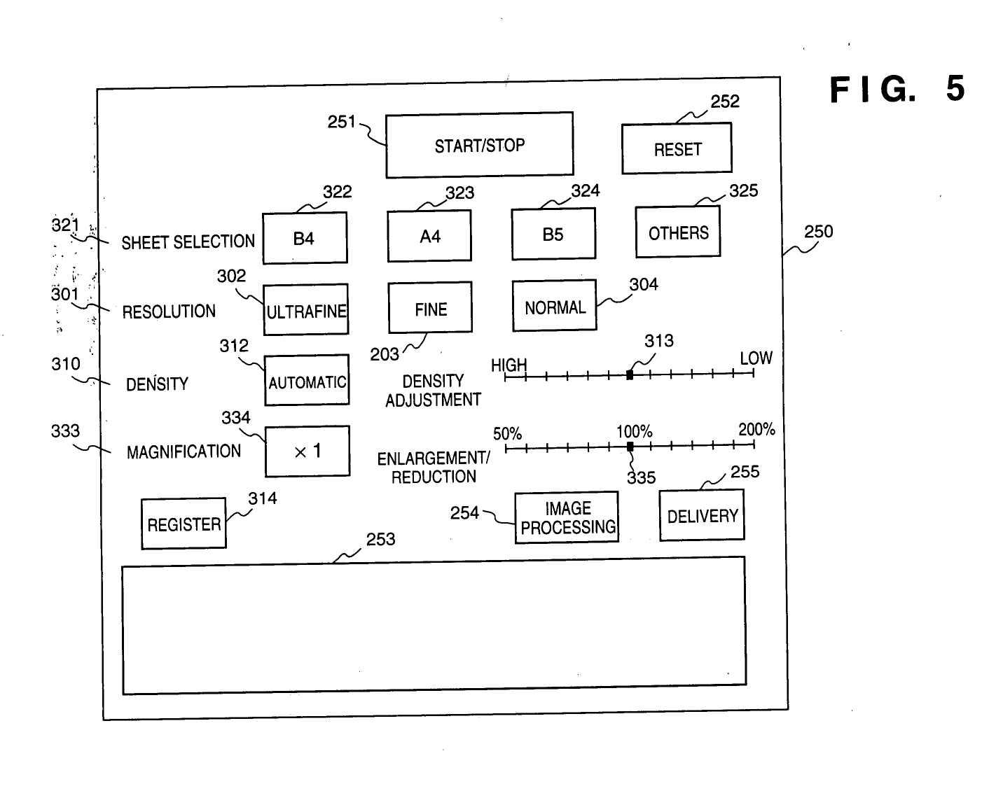

When the copy key 259 and the detail set key 256 are depressed on the initial menu, the display shifts to FIG. 5. In this display, part of the display shown in FIG. 3 and part of that shown in FIG. 4 are selected. The operation is the same as that described in FIGS. 3 and 4, and a detailed description thereof will be omitted. In FIG. 5, the displays in FIGS. 3 and 4 are partially omitted, though the same input processing is enabled if there is an extra display area.

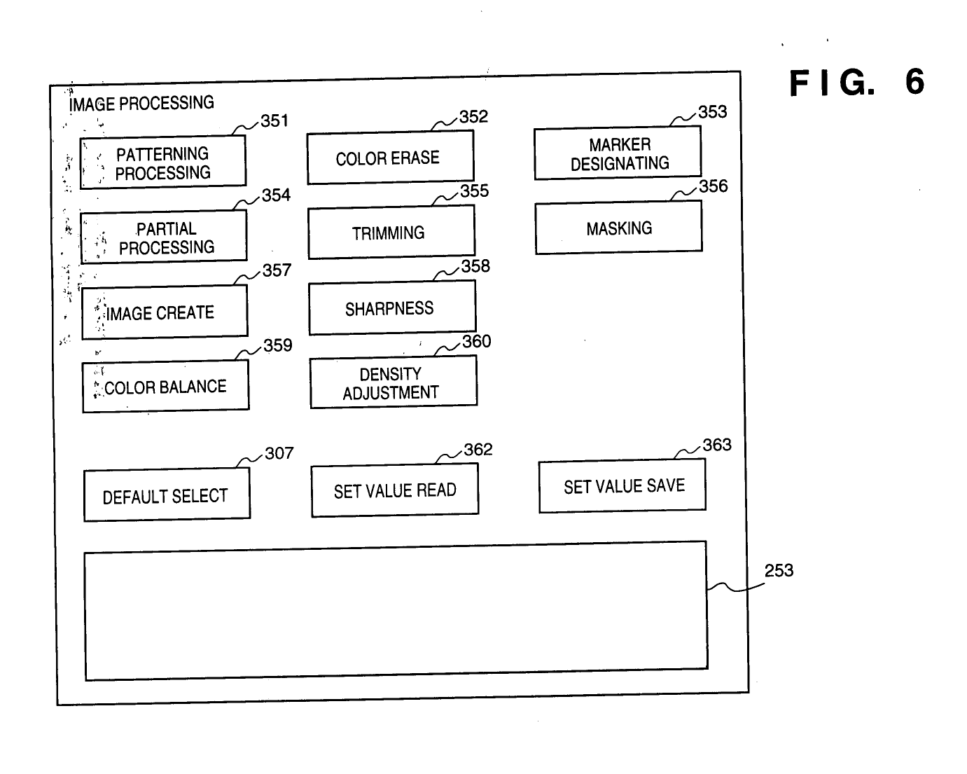

When the image processing key 254 is depressed on the initial menu shown in FIG. 2 during execution of processing shown in FIGS. 3 to 5, the display shifts to an image processing mode, and the operation shifts to processing shown in FIG. 6.

In this case, each image processing shown in FIG. 6 can be executed. The processing is not limited to those, and arbitrary image processing can be executed by changing the program 50.

In this embodiment, a patterning processing key 351 for performing pattern expression, density difference expression, and the like, a color erase key 352 for erasing a specific color, a marker designating key 353 for analyzing an instruction for trimming, marking, or partial processing using a marker of a specific color to perform processing according to the marker, a partial processing key 354 for designating partial processing, a trimming key 355 for designating trimming, a masking key 356 for designating masking, an image create key 357 for designating image create processing such as contour, net, shade, negative/positive conversion processing, and the like, a sharpness key 358 for designating the sharpness of a contour, a color balance key 359 for setting color balance, a density adjustment key 360 for performing density adjustment, the above-mentioned default select key 307 for selecting the default values, a set value read key 362 for reading a set value set in the preceding setting processing, a set value save key 363 for registering the set value in the set value holding unit 5, and the like are arranged.

When the color balance key 359 is selected, the display shift to FIG. 7. Independent color balance adjustment for each color (R, G, or B) for only the scanner unit 10, independent color balance adjustment for each color (Y, M, or C) for only the printer unit 20, interlocked color balance adjustment for each color for both the scanner and the printer can be performed. In interlocked adjustment, one of Y and R, one of M and G, and one of C and B can be selected and adjusted.

In interlocked color balance adjustment, a final print output is corrected to desired colors. Adjustment is possible for only one color. However, the set value holding unit 5 holds three adjustment modes: adjustment values for only the scanner, adjustment values for only the printer, and interlocked adjustment values for both the scanner unit 10 and the printer unit 20 in a copy operation or the like. These values are selected and read in accordance with the operation mode.

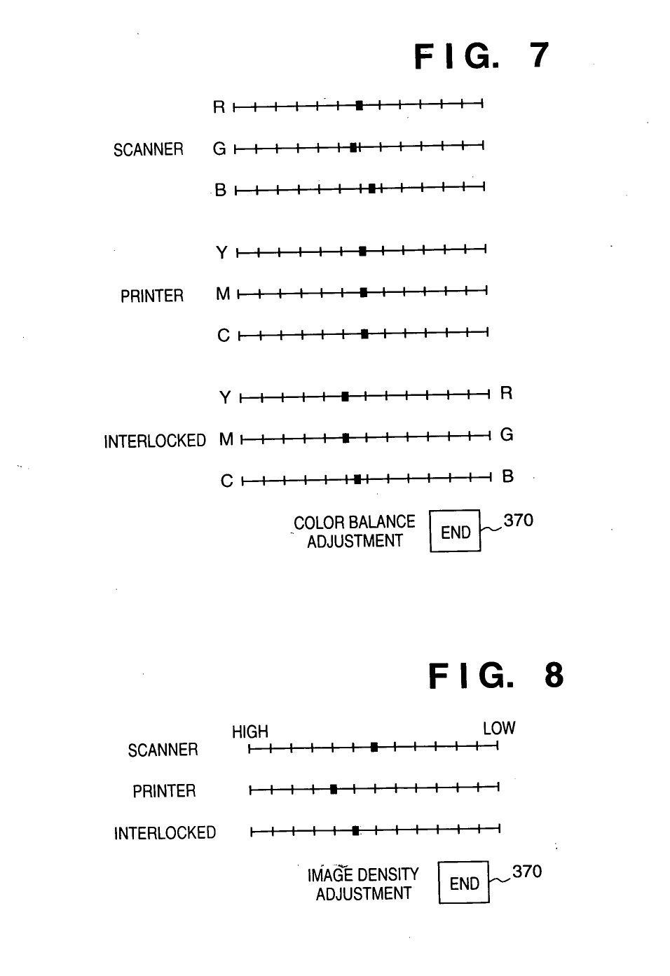

When the density adjustment key 360 in FIG. 6 is depressed, the display shifts to FIG. 8. Density adjustment for only the scanner unit 10, density adjustment for only the printer unit 20, and interlocked density adjustment for both the scanner and the printer can be performed.

The set value holding unit 5 holds three adjustment modes: adjustment values for only the scanner, adjustment values for only the printer, and interlocked adjustment values for both the scanner unit 10 and the printer unit 20 in a copy operation or the like. These values are selected and read in accordance with the operation mode.

A general read operation, a print operation, and a copy operation of this device with the above arrangement will be described below.

[Color Image Read Processing]

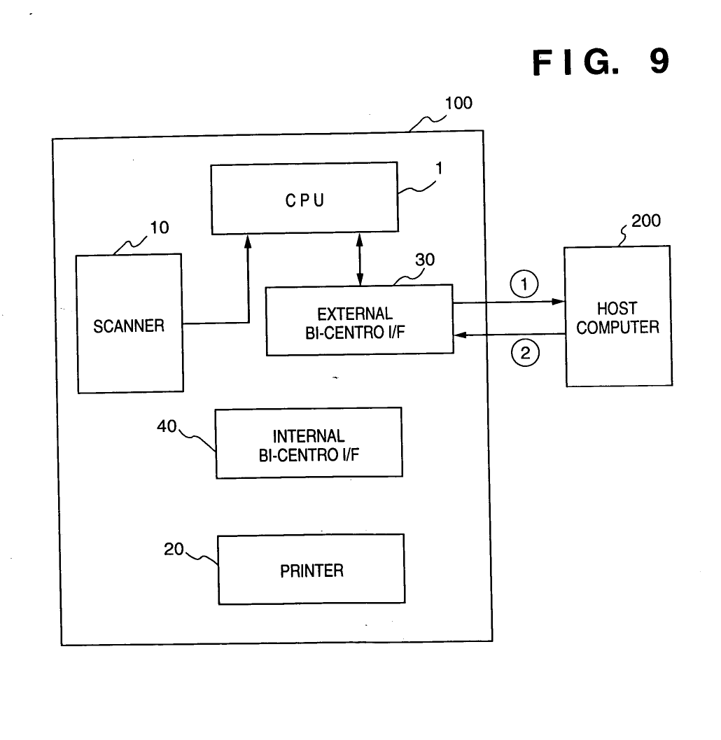

FIG. 9 shows color image read processing of this embodiment.

As shown in FIG. 9, to read a color original image by using the device of this embodiment, the host computer 200 starts, e.g., the scanner driver of the control program 50 for this device, outputs a send request for status information representing the device status, and receives the device status information sent in correspondence with this request through a first bi-centro interface 30 (\mathring{1}). The status information includes a state representing whether the original to be read is set in the scanner unit 10, an on-line/off-line state, a busy status representing that an operation is being performed, and an error.

If it is determined, upon reading the status information, that the device is in an operable state, the host computer 200 starts the scanner and outputs command information for designating to read the original image to the CPU 1 through the first bi-centro interface 30 (\mathring{2}).

The CPU 1 analyzes this command, starts the scanner unit 10 to start the read operation in accordance with the set values in the set value holding unit 5, and transmits read color information to the host computer 200 through the first bi-centro interface 30 (\mathring{1}). With this processing, a color original read operation based on control by the host computer 200 is realized. The read color original can be subjected to desired processing in the host computer 200 and thereafter transmitted to a reception-side device through the modem 201.

[Color Print Operation]

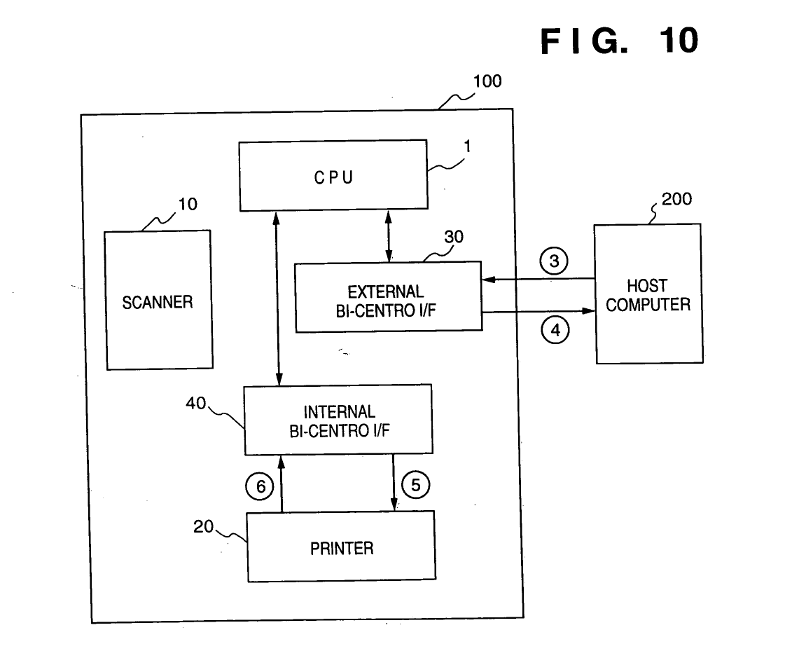

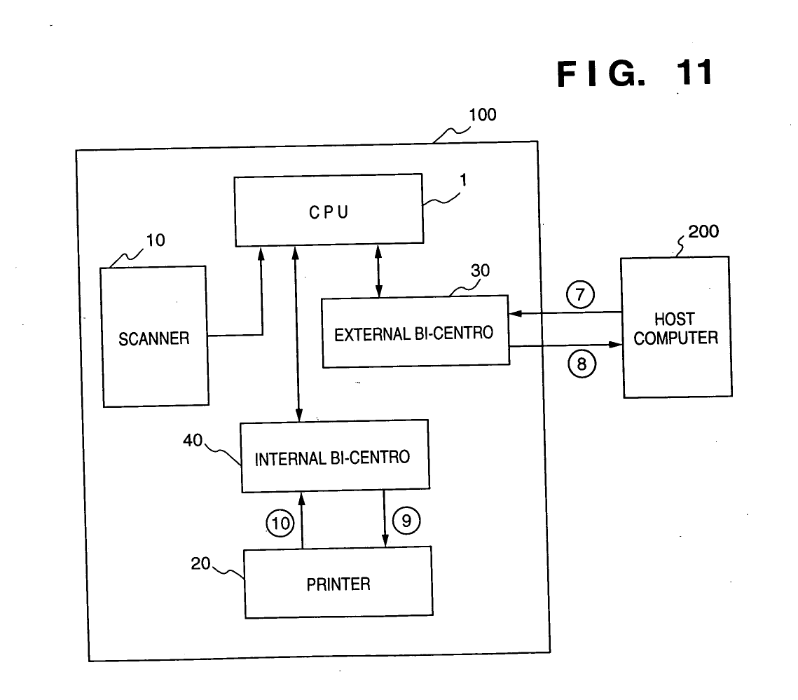

FIG. 10 shows the color print operation of this embodiment.

As shown in FIG. 10, to print and output a color image by using the device of this embodiment, the host computer 200 starts, e.g., the printer driver of the control program 50 for this device, and outputs a send request for status information representing the status of this device to the CPU 1 through the first bi-centro interface 30 (\mathring{3}). Upon reception of this request through the first bi-centro interface 30, the CPU 1 outputs the status information send request to the printer 20 through a second bi-centro 40 (\mathring{5}).

The printer 20 returns status information representing an error or whether recording paper is set to the CPU 1 through the second bi-centro interface 40 (\mathring{6}). Upon reception of the status information from the printer unit 20, the CPU 1 generates status information as the device of this embodiment and transmits the information to the host computer 200 through the first bi-centro interface 30 together with the status information representing the current on-line/off-line state of the device and a busy state representing that an operation is being performed. The host computer 200 receives the device status information through the first bi-centro interface 30 (\mathring{4}).

If it is determined that the device is in an operable state, the host computer 200 outputs print data and command information for designating to start the printer 20 and start the print operation to the CPU 1 through the first bi-centro interface 30 (\mathring{3}).

Upon reception of these command and print data, the CPU 1 designates the printer control unit 22 to start the printer 20 and control the printer unit 20 in accordance with the set values in the set value holding unit 5, and transmits color image data as a print target sequentially sent from the host computer 200 to the printer 20 through the second bi-centro interface 40 in units of predetermined amounts (\mathring{5}). Upon reception of the print information, the printer 20 performs necessary control of the printer engine unit 21 in accordance with the set values in the set value holding unit 5, sequentially feeds recording paper in accordance with the sent print data, and performs a color print operation. With this processing, a color print operation based on control by the host computer 200 is realized.

As a matter of course, the host computer 200 can process the color image received from the transmission-side device through the modem 201 to form color image data as a print target.

[Color Copy Operation]

FIG. 11 shows the color copy operation of this embodiment.

As shown in FIG. 11, to copy and output a color image by using the device of this embodiment, the host computer 200 starts, e.g., the copy driver, or the scanner and printer drivers of the control program 50 for this device, and outputs a send request for status information representing the device status to the CPU 1 through the first bi-centro interface 30 (\mathring{7}). Upon reception of this request through the first bi-centro interface 30, the CPU 1 sends the status information send request to the printer 20 through the second bi-centro interface 40 (\mathring{9}).

The printer 20 returns status information representing an error or whether recording paper is set to the CPU 1 through the second bi-centro interface 40 (10). Upon reception of the status information from the printer unit 20, the CPU 1 generates status information as the device of this embodiment and transmits the information to the host computer 200 through the first bi-centro interface 30 together with the status information representing the current on-line/off-line state of the device and a busy state representing that an operation is being performed. The host computer 200 receives the device status information through the first bi-centro interface 30 (\mathring{8}).

If it is determined, upon reading the status information, that the device is in an operable state, the host computer 200 outputs command information for designating to start the scanner 10 to read the original image and command information for designating to start the printer 20 and start a print operation to the CPU 1 through the first bi-centro interface 30 (\mathring{7}).

The CPU 1 analyzes these commands, starts the scanner 10 to start the read operation in accordance with the set values in the set value holding unit 5, and transmits read color information stored in the RAM 3 by the read image processing unit 14 using DMA to the host computer 200 through the first bi-centro interface 30. The host computer 200 performs necessary image processing to generate color image data to be printed, and sends the target print data to the CPU 1 through the first bi-centro interface 30, which is stored in a predetermined reception area of the RAM 3. The target print data is read using DMA through the second bi-centro interface 40 in units of predetermined amounts and transmitted to the printer control unit 22 through the second bi-centro interface 40 (\mathring{9}). Upon reception of the target print data, the print control unit 22 controls the printer engine unit 21 to feed recording paper in accordance with the sent print data, thereby performing a color print operation. With this processing, a color copy operation based on control by the host computer 200 is realized.

When a plurality of originals are read from the scanner 10, the above processing is repeated.

Color adjustment in the read or print operation by the scanner 10 or the printer 20 is performed in accordance with a standard default value registered in the ROM 2 in advance or a readjustment value specifically set by the user of the host computer 200, which is registered in the set value holding unit 5. A mode for performing all processing in accordance with one of these values or a mode for performing only one corresponding print processing in accordance with one of these values can be selected and executed.

An embodiment of the present invention has been described above, and the scope of the present invention is not limited to this embodiment.

As described above, according to this embodiment, the host computer 200 and the device of this embodiment serving as a scanner unit are connected to each other through the bi-centro interface. For this reason, high-speed information transmission/reception can be performed through a general-purpose interface. The communication medium for connection can be simplified to allow connection to a computer of any type. In addition, since the printer is also connected through the bi-centro interface, an operation as a printer is also enabled in addition to an operation as a scanner, and an operation as a copying machine can also be performed. Furthermore, since the scanner unit 10 can be easily separated from the printer unit 20, only the printer unit 20 or only the scanner unit 10 can be easily replaced. Therefore, the device can easily cope with a change in system configuration.

Since control of image processing or various read/print processing can be executed on the host computer side, the arrangement on the image processing device side can be simplified.

More specifically, the arrangement of an image processing device having a function as a copying machine and capable of integrally constituting a scanner and a printer can be simplified, and a low cost can be achieved in consideration of general personal users. In this case as well, limitations in types of computers to be connected can be eliminated, and the optimum arrangement for realizing facilitation of upgrading of the device and minimizing the upgrading cost can be realized.

The concept of this embodiment may be applied to a system constituted by a plurality of equipments, or to an apparatus comprising a single equipment.

The concept of this embodiment is also applicable to a case where the object of the invention is achieved by supplying a program to a system or apparatus, as a matter of course.

When part or all of various image processing by the scanner unit 10 and the printer unit 20 is to be performed on the host computer 200 side, read data is transmitted to the host computer 200 through the first bi-centro interface 30. The host computer 200 performs necessary image processing to generate print data, and sends the print data to the CPU 1 through the external bi-centro interface 30 again. For this reason, the CPU 1 can receive this print data and send the data to the printer unit 20 through the second bi-centro interface 40 for print and output processing.

If a plurality of originals are read from the scanner 10, the read data is sequentially transmitted to the host computer 200, and the print data is sequentially received.

A case wherein various image processing is mainly performed on the host computer 200 side has been described above. The read image processing unit 14, the printer control unit 22, and the CPU 1 of this embodiment can execute image processing necessary for the copy operation. Instead of sending a read image to the host computer 200 through the external bi-centro interface 30, the CPU 1 can be controlled to directly send color read information received from the scanner 10 to the printer unit 20 through the internal bi-centro interface 40. In this case, image data need not be transferred through the external bi-centro interface 30, thereby reducing the load of the host computer 200 and simplifying processing. Off-line copy processing is also enabled independently of the status of the host computer 200. Therefore, the device of this embodiment is preferably constituted to execute image processing alone to some extent, and the host computer 200 is preferably constituted to execute specific image processing.

Processing necessary in the read image processing unit 14, the CPU 1, and the printer control unit 22 in order to perform color image processing necessary for a color copy operation in the image processing device main body without interposing the host computer 200 will be described below.

In the read image processing unit 14, at least a read image signal must be changed from a state having characteristics unique to the sensor or filter of the scanner to a state commonly processible by the CPU 1 or the host computer 200. For example, shading correction, input masking processing, or conversion processing from chrominance signals in a color expression form unique to the scanner to chrominance signals in a color expression form processible by the host computer 200 is necessary.

In the CPU 1 and the printer control unit 22, at least chrominance signals commonly processible by the CPU 1 and the host computer must be changed to a state suitable for print processing by the printer. For example, output masking processing, black extraction processing, UCR processing, or conversion processing from chrominance signals in a color expression form processible by the host computer 200 to chrominance signals in a color expression form specific for the printer is necessary.

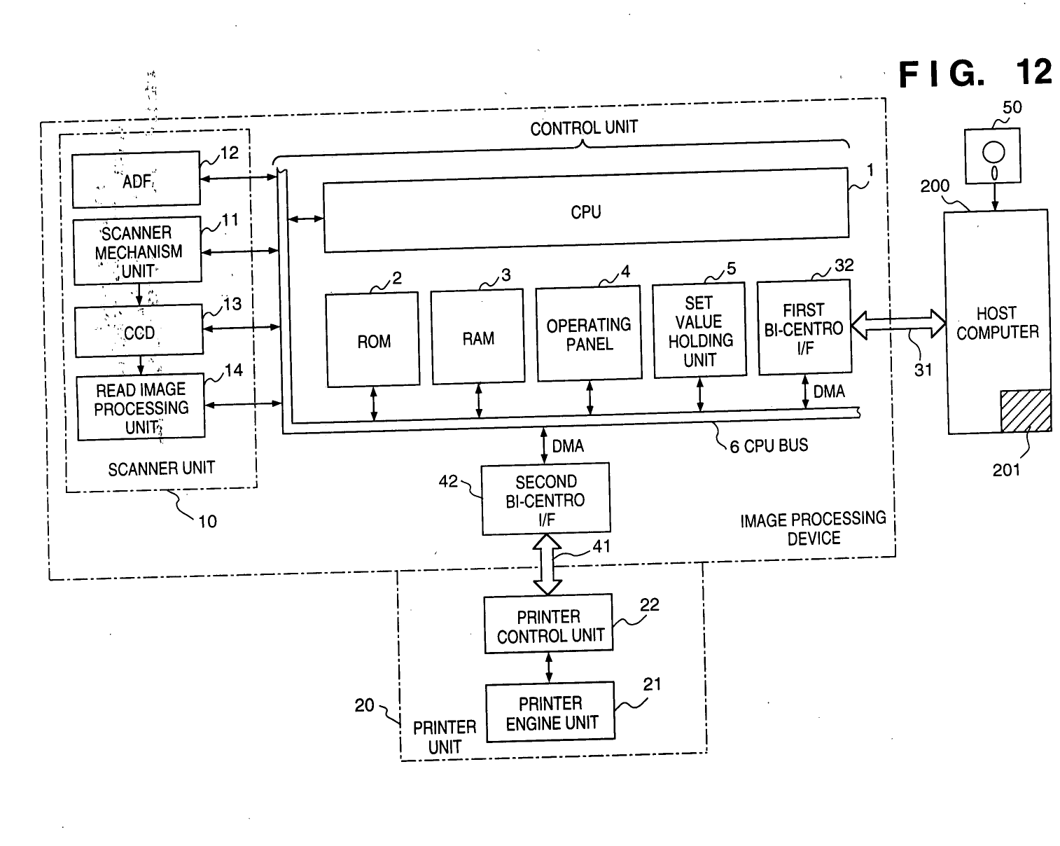

The second embodiment of the present invention will be described below with reference to FIGS. 12 to 15. The same reference numerals as in FIGS. 1 to 11 denote the same or similar blocks in FIGS. 12 to 15, and a detailed description thereof will be omitted. The second embodiment largely differs from the first embodiment in that an image processing device main body has no printer unit, a printer unit 20 is externally arranged, and this external printer unit 20 is connected to a CPU bus 6 of the image processing device main body through a second bi-centro interface 42.

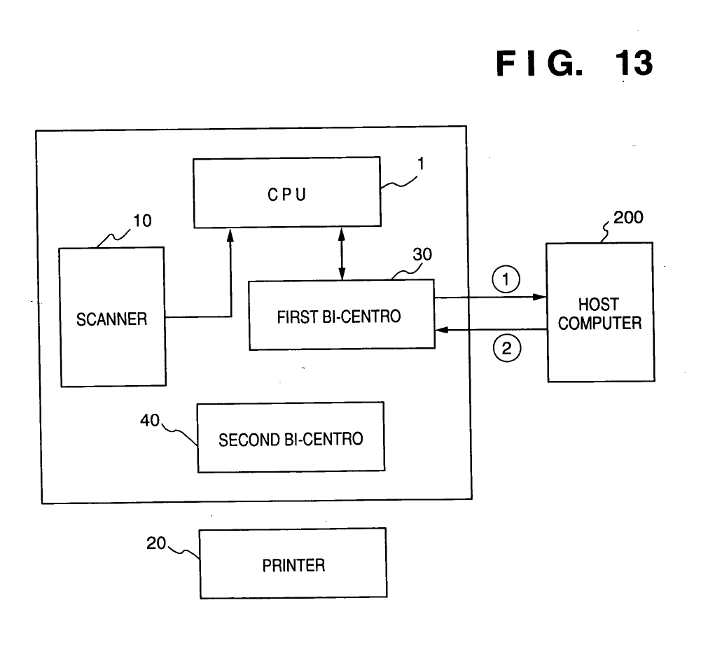

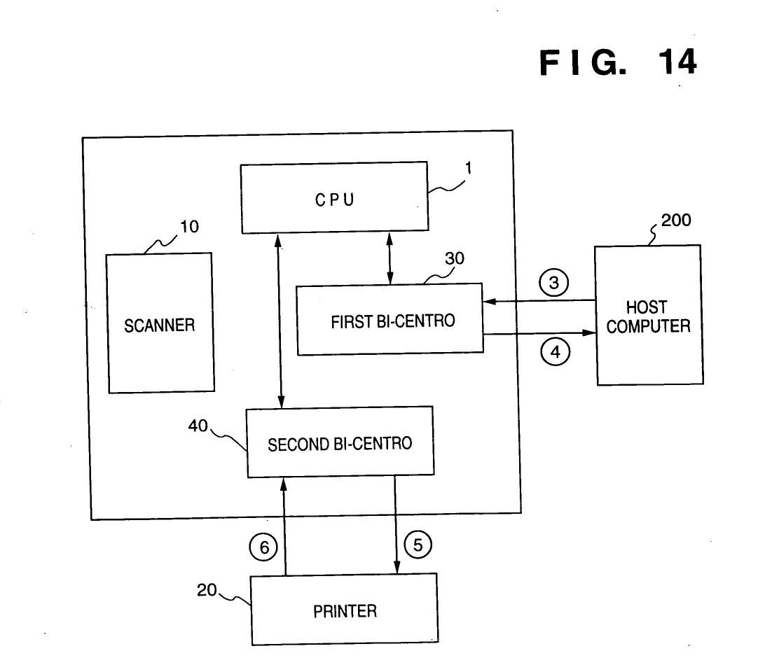

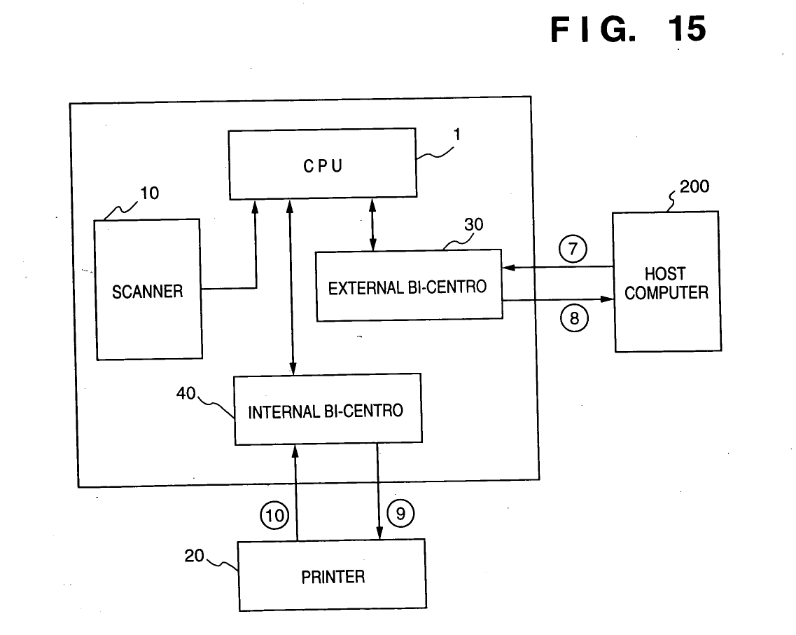

FIG. 12 is a block diagram showing the overall arrangement of this embodiment. FIGS. 13 to 15 are block diagrams for explaining the operations of the system in FIG. 12, in which FIG. 13 shows the operation in color image read processing, FIG. 14 shows the operation in color image print processing, and FIG. 15 shows the operation in color copy processing.

These operations are the same as those in the first embodiment described with reference to FIGS. 1 to 11. In the system shown in FIG. 12, however, the printer unit 20 can be further easily replaced. Therefore, a larger number of types of default values stored in a ROM 2 or a RAM 3 must be set.

In the embodiment shown in FIGS. 12 to 15, the device is connected to the external printer through the general-purpose interface. For this reason, only the printer unit can be easily replaced. In addition, even if a trouble should occur, the failed portion can be easily identified. Therefore, an image processing device capable of easily exchanging only a failed portion can be provided.

As many apparently widely different embodiments of the present invention can be made without departing from the spirit and scope thereof, it is to be understood that the invention is not limited to the specific embodiments thereof except as defined in the appended claims.

1-23. (canceled)

24. An image processing device comprising:
a scanner for reading an image of a document and outputting an image signal;
a control unit adapted for controlling said image processing device and performing image processing on the image signal output from said scanner, to provide a first processed image signal, the image processing being processing that is necessary for copying;
a first bidirectional general-purpose interface adapted for transmitting, under control of said control unit, the image signal output by said scanner to an external computer, which performs image processing on the transmitted image signal to provide a second processed image signal, and for receiving the second processed image signal from the external computer, the image processing performed by the external computer being processing that is necessary for copying; and
a second bidirectional general-purpose interface, of a same standard as said first bidirectional general-purpose interface, adapted for outputting the first processed image signal and the second processed image signal to a printer,
wherein said image processing device has a plurality of modes including a read mode, a print mode, a first copying mode, performed in response to a copying designation by a user, and a second copying mode,
wherein, in the first copying mode, the image signal from said scanner is transmitted to the external computer where the image signal is processed into the second processed image signal via said control unit and said first bidirectional general-purpose interface, and thereafter the second processed image signal is transmitted to the printer via said first bidirectional general-purpose interface, said control unit, and said second bidirectional general-purpose interface, so as to perform copying based on the second processed image signal,
wherein, in the second copying mode, the image signal from said scanner is transmitted to said control unit where the image signal is processed into the first processed image signal and the first processed image signal is transmitted to the printer via said second bidirectional general-purpose interface, so as to perform copying based on the first processed image signal, and
wherein the image processing performed by the external computer in the first copying mode is different from the image processing performed by the control unit in the second copying mode.

25-26. (canceled)

27. An image processing method for an image processing device capable of operating in a plurality of modes including a read mode, a print mode, a first copying mode, and a second copying mode, said method comprising the steps of:
in the first copying mode, performed in response to a copying designation by a user:
reading an image of a document and outputting an image signal by means of a scanner;
transmitting the image signal output by the scanner to an external computer, via a first bidirectional general-purpose interface, wherein the external computer performs image processing on the transmitted image signal to provide a second processed image signal, the image processing being processing that is necessary for copying;
receiving the second processed image signal from the external computer via the first bidirectional general-purpose interface; and
outputting the second processed image signal to a printer via a second bidirectional general-purpose interface of a same standard as the first bidirectional general-purpose interface, and
in said second copying mode:
reading an image of a document and outputting an image signal by the scanner;
performing, in a control unit for controlling the image processing device, image processing on the image signal output by the scanner, to provide a first processed image signal, performed by the control unit the image processing being processing that is necessary for copying; and
outputting the first processed image signal to the printer via the second bidirectional general-purpose interface,
wherein each of the first and second copying modes is performed in response to a designation of corresponding one of the first and second copying modes, and
wherein the image processing performed by the external computer in the first copying mode is different from the image processing performed by the control unit in the second copying mode.

28. (canceled)

29. The method according to claim 27, wherein the transmitted image signal is processed by the external computer and transmitted to a public telephone line.

30-57. (canceled)

58. The image processing device according to claim 24, wherein said scanner generates a color image signal.

59. The image processing device according to claim 24, wherein said control unit has a density adjusting function.

60-61. (canceled)

62. An image processing method using an image processing device capable of operating in a plurality of modes including a read mode, a print mode, a first copying mode in response to a copying designation by a user, and a second copying mode, said method comprising the steps of:
reading an image of a document and outputting an image signal by means of a scanner;
in the first copying mode, transmitting the image signal output by the scanner to an external computer, via a first bidirectional general-purpose interface, performing image processing on the transmitted image signal in the external computer to provide a first processed image signal, transmitting the first processed image signal to the image processing device, via the first bidirectional general-purpose interface, and outputting the first processed image signal to a printer via a second bidirectional general-purpose interface of a same standard as the first bidirectional general-purpose interface, the image processing being processing that is necessary for copying; and
in the second copying mode, performing image processing on the image signal output by the scanner, in a control unit for controlling the image processing device, to provide a second processed image signal and outputting the second processed image signal to the printer via the second bidirectional general-purpose interface, performed by the control unit the image processing being processing that is necessary for copying, and
wherein the image processing performed by the external computer in the first copying mode is different from the image processing performed by the control unit in the second copying mode.

63. An image processing system comprising:
an information processing apparatus comprising:
a read designation unit, adapted to designate a start for reading of a document;
a print designation unit, adapted to designate a start for printing data that said information processing apparatus transmits;
a copying designation unit, adapted to designate a start for copying; and
a processing unit, adapted to process an image signal to provide a second processed image signal; and
an image processing apparatus comprising:
a scanner for reading an image of a document and outputting an image signal;
a control unit, adapted for controlling said image processing apparatus and performing image processing on the image signal output from said scanner, to provide a first processed image signal, the image processing being processing that is necessary for copying;
a first bidirectional general-purpose interface for transmitting, under control of said control unit, the image signal output by said scanner to said information processing apparatus, which performs image processing on the transmitted image signal to provide the second processed image signal, and for receiving the second processed image signal from said information processing apparatus, performed by said image processing apparatus the image processing being processing that is necessary for copying;
a second bidirectional general-purpose interface, of a same standard as said first bidirectional general-purpose interface, adapted for outputting the first processed image signal and the second processed image signal to a printer; and
a copy key for designating a start for copying,
wherein said image processing apparatus has a plurality of modes including a read mode performed in response to a read designation by said information processing apparatus, a print mode performed in response to a print designation by said information processing apparatus, a first copying mode performed in response to a copying designation by said information processing apparatus, and a second copying mode,
wherein, in the first copying mode, the image signal from said scanner is transmitted to said information processing apparatus where the image signal is processed into the second processed image signal via said control unit and said first bidirectional general-purpose, interface and thereafter the second processed image signal is transmitted to the printer via said first bidirectional general-purpose interface, said control unit, and said second bidirectional general-purpose interface so as to perform copying based on the second image signal,
wherein, in the second copying mode, the image signal from said scanner is transmitted to said control unit where the image signal is processed into the first processed image signal and the first processed image signal is transmitted to the printer via said second bidirectional general-purpose interface so as to perform copying based on the first processed image signal, and
wherein the image processing performed by the external computer in the first copying mode is different from the image processing performed by the control unit in the second copying mode.

64. An image processing device comprising:
a scanner for reading an image of a document and outputting an image signal;
a control unit adapted for controlling said image processing device and performing image processing on the image signal output from said scanner, to provide a first processed image signal, the image processing being processing that is necessary for copying;
a first interface adapted for transmitting the image signal output by said scanner to an external computer, which performs image processing on the transmitted image signal to provide a second processed image signal, and for receiving the second processed image signal from the external computer, the image processing performed by the external computer being processing that is necessary for copying; and
a second interface adapted for outputting the first processed image signal and the second processed image signal to a printer,
wherein said image processing device has a first copying mode performed in response to a copying designation by a user, and a second copying mode,
wherein, in the first copying mode, the image signal is transmitted to the external computer where the image signal is processed into the second processed image signal via said control unit and said first interface, and thereafter the second processed image signal is transmitted to the printer via said first interface, said control unit, and said second interface, so as to perform copying based on the second processed image signal,
wherein, in the second copying mode, the image signal is transmitted to said control unit where the image signal is processed into the first processed image signal and the first processed image signal is transmitted to the printer via said second interface, so as to perform copying based on the first processed image signal, and
wherein the image processing performed by the external computer in the first copying mode is different from the image processing performed by said control unit in the second copying mode.

65. The image processing device according to claim 64, wherein, in the first copying mode, said control unit receives command information for designating the start of the scanner to read the image from the external computer via said first interface, controls the scanner to start a read operation in accordance with the command information, transmits the image signal to the external computer via said first interface, receives print data as the second processed image signal from the external computer via said first interface and transmits the print data as the second processed image signal to the printer via said second interface.

66. The image processing device according to claim 64, wherein said image processing device has a print mode, in which print data is transmitted from the external computer to said control unit via said first interface and the printer prints the print data, and an image reading mode in which an image signal from the scanner is transmitted from said control unit to the external computer via said first interface.

67. An image processing method for an image processing device capable of operating in a first copying mode and a second copying mode, said method comprising the steps of:
in the first copying mode, performed in response to a copying designation by a user:
reading an image of a document and outputting an image signal by a scanner;
transmitting the image signal output by the scanner to an external computer, via a first interface, wherein the external computer performs image processing on the transmitted image signal to provide a second processed image signal, the image processing being processing that is necessary for copying;
receiving the second processing image signal from the external computer via the first interface; and
outputting the second processed image signal to a printer via second interface, and
in the second copying mode:
reading an image of a document and outputting an image signal by the scanner,
performing, in a control unit for controlling the image processing device, image processing on the image signal output by the scanner, to provide a first processed image signal, the image processing being processing that is necessary for copying; and
outputting the first processed image signal to the printer via the second interface,
wherein the image processing performed by the external computer in the first copying mode is different from the image processing performed by said control unit in the second copying mode.
